(19) United States
(12) Patent Application Publication
(10) Pub. No.: US 2007/0084688 A1
(43) Pub. Date: Apr. 19, 2007

(54) Collapsible member

(76) Inventors: Kevin Lyle Gilleo, Dexter, MI (US); Sheldon Zane Brown, Farmington Hills, MI (US)

Correspondence Address: GIFFORD, KRASS, SPRINKLE,;ANDERSON & CITKOWSKI, P.C., P.O. BOX 7021, TROY, MI, 48007-7021, US

(21) Appl. No.: 11/253,859

(22) Filed: Oct. 19, 2005

(51) Int. Cl. F16F 7/12

(52) U.S. Cl. 188/377

(57) ABSTRACT

A collapsible member that includes a base. The base includes slots that are formed therein. A projection member extends from the base and includes at least two stepped portions that are spaced from each other. The at least two stepped portions include a varying thickness allowing a controlled collapse of the collapsible member in response to application of a predetermined force.

### FIELD OF THE INVENTION

The invention relates to collapsible members, and more particularly to collapsible members which in response to application of a predetermined force collapse in a controlled manner.

### BACKGROUND OF THE INVENTION

Datums and locators are commonly used in the automotive industry to position one component relative to another. Additionally, such locators and datums are utilized for attachment of one component to another. Such locators and datums are usually of a predetermined size and configuration to locate one component relative to another in a specific packaging space. The prior art datum and locators do not collapse in a controlled manner in response to application of a predetermined force.

There is therefore a need in the art for a collapsible member suitable for use as a datum or locator that collapses in a controlled manner upon the application of a predetermined force. For example, datums or locators positioned within a crush zone for an impact test would need to be positioned outside of a crush zone associated with an occupant of a vehicle to meet safety standards. Through the use of a collapsible member, locators and datums may be positioned within a crush zone where fixed datums or locators could not be positioned.

There is also a need in the art for a collapsible member to control the rate at which one component moves relative to another upon the application of a predetermined force. Such a collapsible member can be tuned to collapse in a controlled manner across a wide range of forces by varying the design parameters to control both the rate of collapse, as well as the amount of collapse.

### SUMMARY OF THE INVENTION

A collapsible member that includes a base. The base includes slots that are formed therein. A projection member extends from the base and includes at least two stepped portions that are spaced from each other. The at least two stepped portions include a varying thickness allowing a controlled collapse of the collapsible member in response to application of a predetermined force.

### BRIEF DESCRIPTION OF THE DRAWINGS

FIG. 1 is a partial sectional view showing a collapsible member according to the present invention;

FIG. 2 is a top view of the collapsible member shown in FIG. 1;

FIG. 3 is a partial top view of a base of a collapsible member showing the slots formed in the base.

### DETAILED DESCRIPTION OF THE PREFERRED EMBODIMENTS

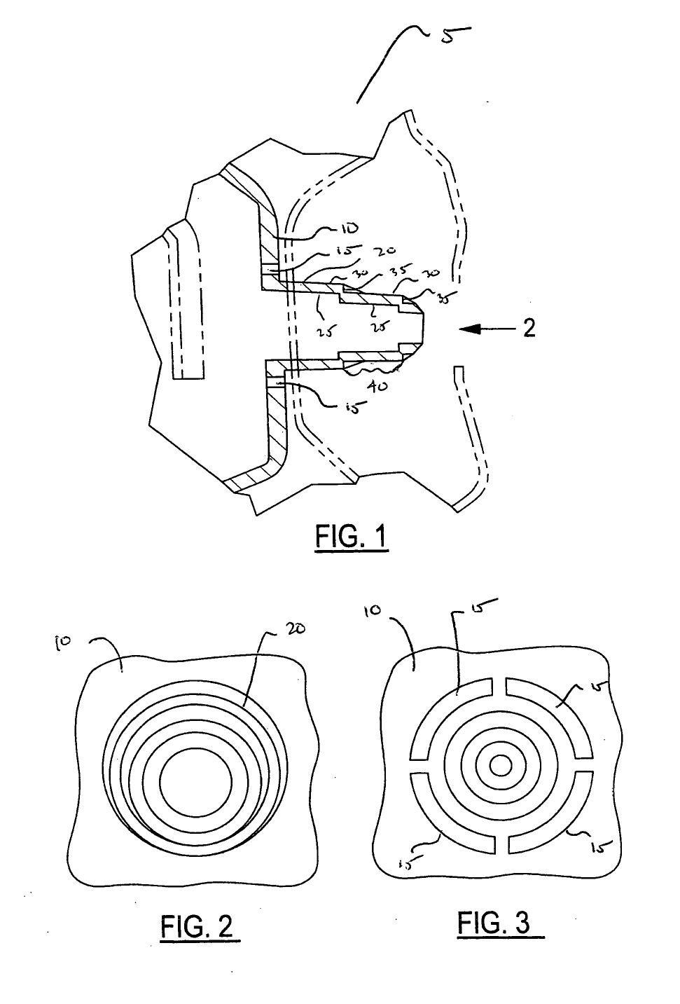

Referring to FIG. 1, there is shown a sectional view of a collapsible member 5 according to the present invention. The collapsible member 5 includes a base 10 that has slots 15 formed therein. A projection member 20 extends from the base 10 and includes at least two stepped portions 25 that are spaced from each other. The projection member 20 shown in FIG. 1 includes three stepped portions 25, although any number of stepped portions 25 may be utilized to control the rate of collapse as well as the length of the collapse of a collapsible member 5. Additionally, the stepped portions 25 include a varying thickness allowing for a controlled or staged collapse of the collapsible member 5 in response to application of the predetermined force.

The stepped portions 25 include a first portion 30 which is shown as a generally horizontal surface in FIG. 1 and a second portion 35 which is shown as a generally vertical surface in FIG. 1. It should be realized that the first 30 and second portions 35 may be angled relative to vertical and horizontal references, as well as relative to each other, as will be discussed in more detail below. In one aspect of the invention, the first portion 30 of one of the stepped portions 25 is connected with the second portion 35 of another stepped portion 25. In this manner, the stepped portions 25 of the projection member 20 are linked relative to each other.

In one aspect of the invention, the thickness of the second portion 35 of the stepped portions 25 is less than the thickness of the first portion 30 of the stepped portions 25. In this manner, the stepped portions 25 telescopically collapse inside one another as the second portion 35 breaks away upon the application of a predetermined force. It should be realized by one of skill in the art that the thickness can be varied to allow the collapse of the stepped portions 25 across a wide range of forces. Additionally, in another aspect of the invention the thicknesses of the spaced second portions 35 of the stepped portions 25 differ from one another thereby causing a staged collapse of the second portions 35 after application of the predetermined force. For example, the thickness of the second portion 35a of the step located furthest from the base 10 may have a thickness that is less than the adjacent spaced stepped portion 25b such that when a force is applied in a direction corresponding to the arrow of FIG. 1 that the stepped portion 25a furthest from the base 10 would collapse first followed by collapse of the next stepped portion 25b. In this manner, a staged or controlled collapse of the collapsible member 5 can be achieved.

Referring to FIGS. 1 and 2, it can be seen that the stepped portions 25 may have a differing diameter in comparison to another spaced stepped portion 25. Additionally it can be seen that the diameter size of the stepped portion 25 decreases as the stepped portions 25 is positioned away from the base 10. This orientation provides a tapered profile of the collapsible member 5 suitable for use as a locator or datum. Additionally, the stepped members can include a tapered profile such that the first portion 30 of the stepped portion 25 has an angle relative to the horizontal or vertical axis depending on the position of the collapsible member 5. Again, such a tapered profile assists in the use of a collapsible member 5 as a locator or datum.

Referring to FIG. 3, there is shown the base 10 of the collapsible member 5 having slots 15 formed therein. As can be seen from the figure, the slots 15 are formed in a circular pattern about the projection portion. The embodiment shown in FIG. 3 includes four slots 15 positioned circumferentially about the projection portion. Each of these slots 15 is separated from each other by a distance 40. It should be realized that any number of slots 15 having various distances 40 between them as well as orientations may be utilized by the present invention. For example, the slots 15 may be positioned in any relative pattern such as the circular one shown or other patterns including hexagonal, rectangular, square, or any polygon type shape can be utilized to adjust the controlled collapse of the collapsible member 5. In one aspect of the invention, the slots 15 formed in the base 10 define a weakened zone allowing the projection portion to break through the base 10 after application of the predetermined force. In this manner, the staged collapse of the stepped portions 25 may be followed by the bottom step breaking away from the base 10 such that the projection portion breaks and collapses through the base 10 after application of the predetermined force.

As stated above, various parameters associated with the collapsible member 5 including the angular relationship between various stepped portions 25, the thicknesses of various components, as well as the position and orientation of various components such as the slots 15 and the base 10 can be tuned such that the collapsible member 5 will respond to any number of predetermined forces, as the situation requires such that a controlled collapse of the collapsible member 5 is achieved.

The invention has been described in an illustrative manner. It is to be understood that the terminology which has been used is intended to be in the nature of words of description rather than limitation. Many modifications and variations of the invention are possible in light of the above teachings. Therefore, within the scope of the appended claims, the invention may be practiced other than as specifically described.

1. A collapsible member comprising:
a base, the base including slots formed therein;
a projection member extending from the base, the projection member including at least two stepped portions spaced from each other;
wherein the at least two stepped portions include a varying thickness allowing a controlled collapse of the collapsible member in response to application of a predetermined force.

2. The collapsible member of claim 1 wherein each of the at least two stepped portions includes a first portion connected with a second portion.

3. The collapsible member of claim 2 wherein the first portions of the at least two stepped portions are connected with the second portion of one of the at least two stepped portions.

4. The collapsible member of claim 2 wherein the thickness of the second portion of the at least two stepped portions has a thickness less than the thickness of the first portion of the at least two stepped portions.

5. The collapsible member of claim 2 wherein the thickness of the spaced second portions of the at least two stepped portions differs causing a staged collapse of the stepped portions after application of the predetermined force.

6. The collapsible member of claim 1 wherein one of the at least two stepped portions includes a tapered profile.

7. The collapsible member of claim 1 wherein the at least two stepped portions have a differing diameter in comparison to another spaced stepped portion.

8. The collapsible member of claim 7 wherein the diameter size of the stepped portion decreases in relation to another spaced stepped portion in a direction away from the base.

9. The collapsible member of claim 1 wherein the at least two stepped portions comprise a plurality of stepped portions.

10. The collapsible member of claim 1 wherein the slots formed in the base define a weakened zone allowing the projection portion to break through the base after application of the predetermined force.

11. The collapsible member of claim 1 wherein the collapsible member comprises a datum.

12. The collapsible member of claim 1 wherein the collapsible member comprises a location feature.

13. A collapsible member comprising:
a base, the base including slots formed therein;
a projection member extending from the base, the projection member including at least two stepped portions spaced from each other, each of the at least two stepped portions includes a first portion connected with a second portion and wherein the thickness of the second portion of the at least two stepped portions has a thickness less than the thickness of the first portion of the at least two stepped portions allowing a controlled collapse of the collapsible member in response to application of a predetermined force.

14. A collapsible member comprising:
a base, the base including slots formed therein;
a projection member extending from the base;
wherein the slots formed in the base define a weakened zone allowing the projection portion to break through the base after application of a predetermined force.
